(19) United States
(12) Patent Application Publication
(10) Pub. No.: US 2015/0163384 A1
(43) Pub. Date: Jun. 11, 2015

(54) CAMERA MODULE AND MANUFACTURING METHOD THEREOF

(71) Applicants: LITE-ON ELECTRONICS (GUANGZHOU) LIMITED, GUANGZHOU 510663 (CN); LITE-ON TECHNOLOGY CORP., TAIPEI 11492 (TW)

(72) Inventors: TING-CHENG LEE, TAIPEI 11492 (TW); TI-LUN LIU, TAIPEI 11492 (TW)

(21) Appl. No.: 14/554,630

(22) Filed: Nov. 26, 2014

(30) Foreign Application Priority Data
Dec. 9, 2013 (CN) 201320804428.2

(51) Int. Cl. H04N 5/225; G03B 13/34

(52) U.S. Cl. CPC H04N 5/2254; G03B 13/34

(57) ABSTRACT

A camera module includes a sensor unit, a lens unit, and a plurality of conductive members. The sensor unit includes a substrate and an image sensor. The substrate is formed with a plurality of first through holes. The lens unit is disposed on the sensor unit and includes an electrowetting lens device. The electrowetting lens device includes a sealed structure aligned with the image sensor along an optical axis and is formed with a plurality of second through holes. Each of the second through holes is registered with a corresponding one of the first through holes for receiving a corresponding conductive member. A focal length of the electrowetting lens device is adjustably controlled by an electric field applied to the conductive members.

### CROSS-REFERENCE TO RELATED APPLICATION

This application claims priority of Chinese Patent Application No. 201320804428.2, filed on Dec. 9, 2013.

### FIELD OF THE INVENTION

This invention relates to a camera module, more particularly to a wafer-level camera module with an electrowetting lens device.

### BACKGROUND OF THE INVENTION

Currently, electronic devices such as mobile phones, tablet computers, personal computers, etc., are installed with camera modules for image capturing functionality. A conventional camera module includes a lens module and an image sensor. The lens module includes a lens holder and a lens assembly including a lens barrel and an optics module received therein. The lens assembly is threadedly engaged in the lens holder. The lens holder has an end for receiving incoming light. The image sensor is mounted on a substrate and disposed at another end of the lens holder and receives light that passes through the optics module. In order to enhance image quality, the conventional camera module may further include a zoom mechanism having a driving unit, such as a stepper motor, that drives movement of a driven unit, such as a gear unit which is coupled to the lens assembly to change the distance between the optical lens(es) and the image sensor so as to achieve zoom adjustment. However, the use of the driving and driven units increases the overall size and weight and complexity of the conventional camera module. Furthermore, the driving unit is not only energy-consuming but also time-consuming in achieving zoom adjustment. Moreover, since the lens assembly is threadedly engaged in the lens holder, during assembly of the conventional camera module and zoom adjustment thereof, particles may be generated and may affect image quality.

### SUMMARY OF THE INVENTION

According to a first aspect of the present invention, a camera module is provided. The camera module includes a sensor unit, a lens unit disposed on the sensor unit and a plurality of conductive members. The sensor unit includes a substrate and an image sensor disposed on the substrate. The substrate is formed with a plurality of first through holes that are not interfered by the image sensor. The lens unit includes an electrowetting lens device including a sealed structure that is aligned with the image sensor along an optical axis. The sealed structure is formed with a plurality of second through holes. Each of the second through holes is registered with a corresponding one of the first through holes. Each of the conductive members is formed in a corresponding registered pair of the first and second through holes. A focal length of the electrowetting lens device is adjustably controlled by an electric field applied to the conductive members.

According to a second aspect of the present invention, a camera module assembly is provided. The camera module assembly includes a sensor unit array, a lens unit array and a plurality of conductive members. The sensor unit array includes a wafer-like substrate array having a plurality of substrates, and an image sensor array having a plurality of image sensors. The image sensor array is disposed on the substrate array in such a way that the image sensors are respectively disposed on the substrates to form a plurality of sensor units. Each of the substrates is formed with a plurality of first through holes that are not interfered by the image sensor. The lens unit array is made up of a plurality of lens units. The lens unit array includes an electrowetting lens device array including a plurality of electrowetting lens devices. Each of the electrowetting lens devices includes a sealed structure formed with a plurality of second through holes. The lens unit array is disposed on the sensor unit array in such a way that the sealed structure of each of the electrowetting lens devices is aligned with a corresponding one of the image sensors along a corresponding optical axis. Each of the second through holes is corresponding to one of the first through holes. Each of the conductive members is respectively formed in the registered pairs of the first and second through holes.

According to a third aspect of the present invention, a manufacturing method of a plurality of camera modules is provided. The method includes the steps of:

(A) forming a wafer-like structure including a sensor unit array and a lens unit array stacked on the sensor unit array, the sensor unit array including a substrate array that has a plurality of substrates and an image sensor array that has a plurality of image sensors respectively disposed on the substrates of the substrate array to form a plurality of sensor units, the lens unit array being made up of a plurality of lens units and including an electrowetting lens device array that includes a plurality of electrowetting lens devices, each of the electrowetting lens devices including a sealed structure that is aligned with a corresponding one of the image sensors along a corresponding optical axis, each of stacked pairs of the sensor units and the lens units being formed with a plurality of registered pairs of a first through hole and a second through hole;

(B) forming a plurality of conductive members respectively in the pairs of the first and second through holes; and

(C) after step (B), dicing the wafer-like structure to form a plurality of camera modules, each of the camera modules including one of the sensor units, one of the lens units and a plurality of the conductive members.

### BRIEF DESCRIPTION OF THE DRAWINGS

Other features and advantages of the present invention will become apparent in the following detailed description of the embodiment with reference to the accompanying drawings, of which:

FIG. 1 is a fragmentary cross-sectional view of a camera module according to an embodiment of the present invention;

FIG. 2 is a view similar to FIG. 1 illustrating a camera module according to an alternative embodiment of the present invention;

FIG. 3 is a cross-sectional view of the camera module according to the embodiment shown in FIG. 1;

FIG. 4 is a cross-sectional view of the camera module according to the embodiment shown in FIG. 1 under the influence of an applied electric field;

FIG. 5 is a fragmentary top schematic view of the camera module according to the embodiment shown in FIG. 1, illustrating application of opposite electric fields to the first and second fluids via the conductive members;

FIG. 6 is another fragmentary top schematic view of the camera module according to the embodiment shown in FIG. 1, illustrating an alternative way to apply electric fields to the first and second fluids;

FIG. 7 is a cross-sectional view of the camera module according to another alternative embodiment of the present invention;

FIG. 8 is a flowchart of a method of manufacturing a plurality of the camera modules according to the embodiment of the present invention;

FIGS. 9 to 12 are fragmentary cross-sectional views illustrating the manufacturing of a camera module assembly according to the method; and

FIG. 13 is a view similar to FIG. 12 but illustrating a camera module assembly according to the alternative embodiment of the present invention.

### DETAILED DESCRIPTION OF THE EMBODIMENT

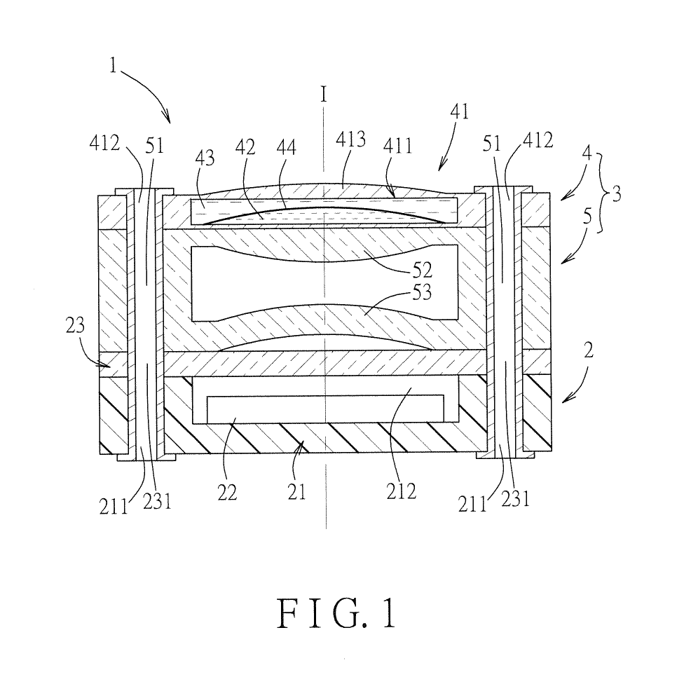

Referring to FIGS. 1 and 3 to 6, according to an embodiment of the present invention, a camera module 1 is provided. The camera module 1 could be installed on a mobile phone, a tablet computer, a personal computer, etc. The camera module 1 includes a sensor unit 2, a lens unit 3 and a plurality of conductive members 6.

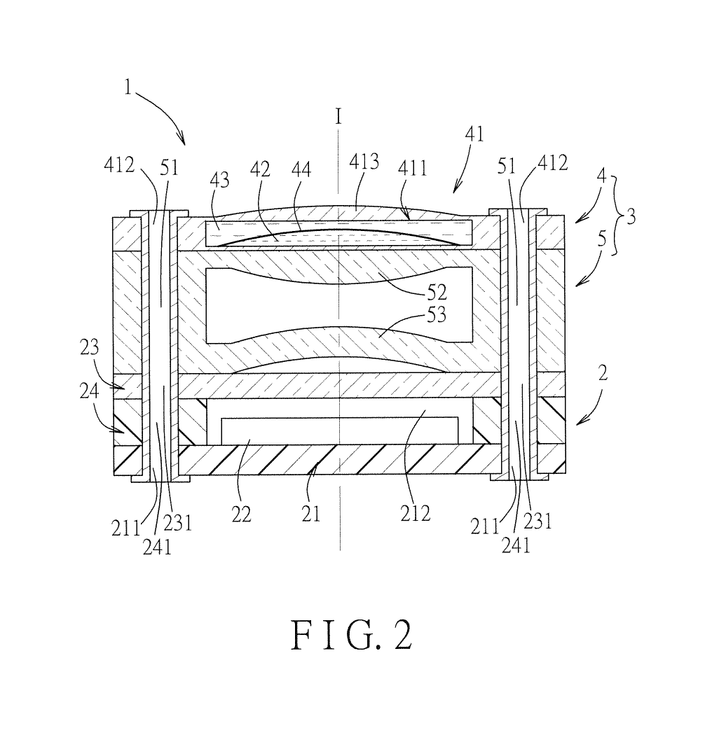

The sensor unit 2 includes a substrate 21 and an image sensor 22 disposed on the substrate 21. In this embodiment, the substrate 21 is illustrated as a circuit board formed with a recess 212 at a top surface thereof for placement of the image sensor 22. In an alternative embodiment of the present invention, as shown in FIG. 2, the substrate 21 may be a flat circuit board, while the sensor unit 2 further includes a spacer 24 that is disposed on the substrate 21 and that surrounds the image sensor 22. It should be noted that the substrate 21 may also be a holding plate made of e.g., ceramics, plastics, etc., in which case the sensor unit 2 further includes a circuit board (not shown) disposed be low the substrate 21. The image sensor 22 is electrically connected to the circuit board through techniques such as wire bonding, chip scale package (CSP), ball grid array (BOA), flip chip (FC), etc. The image sensor 22 could be a complementary metal oxide semiconductor (CMOS) sensor or the like that is capable of receiving incident light and converting optical images into electronic signals.

The sensor unit 2 further includes a light-transmissive cover 23 that covers the substrate 21 and the image sensor 22. The cover 23 is made of glass, plastics, or other light-transmissive materials. The cover 23 may serve the functions of supporting, protecting, light filtering, anti-reflecting, etc. In other embodiment, the cover 23 may be omitted.

The lens unit 3 is disposed on the sensor unit 2 and includes an electrowetting lens device 4 and a lens structure 5. The electrowetting lens device 4 includes a sealed structure 41 that is aligned with the image sensor 22 of the sensor unit 2 along an optical axis I, and contains two immiscible fluids, a first fluid 42 and a second fluid 43. The first fluid 42 is conductive and the second fluid 43 is non-conductive. The sealed structure 41 is made from a light-transmissive material. The surfaces of the sealed structure 41 may be planar, curved, or freeform. One side of the sealed structure 41 opposite to the image sensor 22 may be further formed with a lens 413 for condensing incident light. It should be noted that the surface morphology of the sealed structure 41 may be designed according to practical requirements and should not be limited by the embodiment of the present invention.

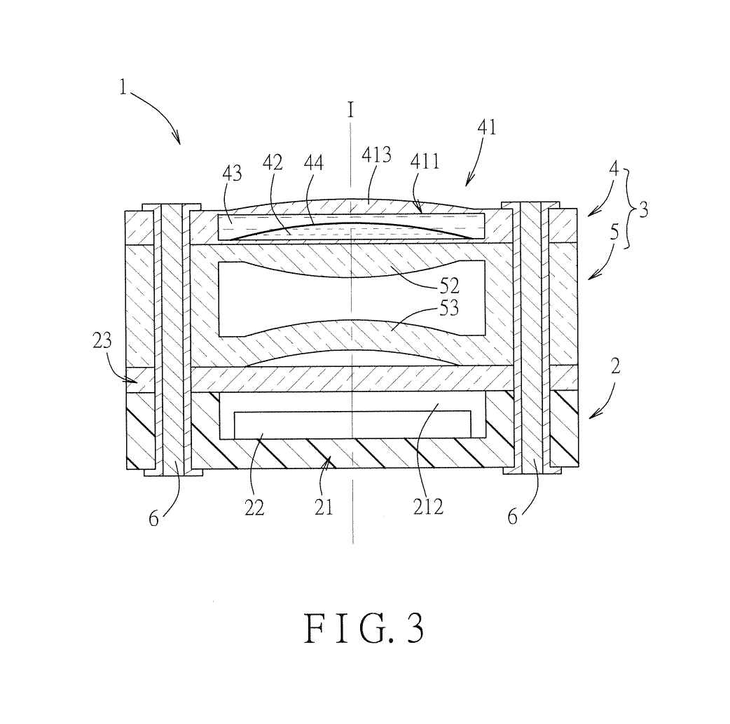

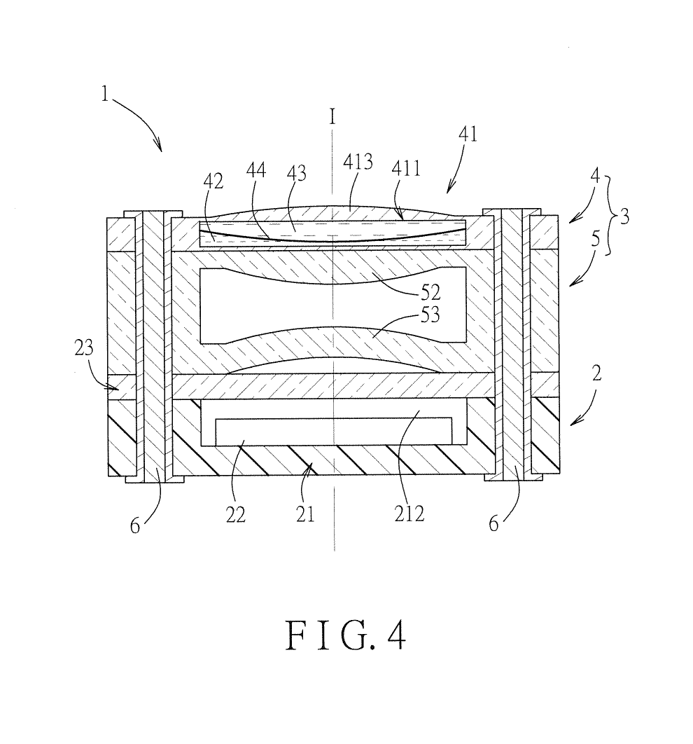

The sealed structure 41 of the electrowetting lens device 4 is formed with a chamber 411 and the first and second fluids 42, 43 are accommodated in the chamber 411. The inner surface of the chamber 411 may be hydrophobically treated. The second fluid 43 may be a non-conductive silicone oil. The first fluid 42 may be a conductive solution comprising for example an aqueous solution. The first fluid 42 and the second fluid 43 are immiscible. Where the two fluids meet they form an optical interface 44 in the form of a meniscus, which can have a number of different shapes (see FIGS. 3 and 4). The interface 44 formed between the two immiscible fluids is to be aligned with the image sensor 22 along the optical axis I.

As illustrated herein, the lens structure 5 is disposed between the electrowetting lens device 4 and the sensor unit 2. The sensor unit 2, the electrowetting lens device 4 and the lens structure 5 are aligned with one another along the optical axis I. The lens structure 5 may include at least one lens portion that is aligned with the image sensor 22 along the optical axis I for adjusting an optical path. The lens structure 5 may be a solid lens that contributes to optical imaging. In the embodiment of the present invention, the lens structure 5 is a solid lens, and includes a first lens portion 52 and a second lens portion 53 that are aligned along the optical axis I. Both of the first and second lens portions 52, 53 are convex lenses for condensing incident light. It should be noted that the first and second lens portions 52, 53 may both be concave lenses or may be a combination of a convex lens and a concave lens according to practical requirements. The number of the lens portions is also dependent on practical requirements and should not be limited by the embodiment of the present invention. The lens structure 5 may also be formed with curved surfaces and without any lens portions. Alternatively, the lens structure 5 may be disposed on the electrowetting lens device 4 opposite to the sensor unit 2.

The camera module 1 may further include the lens structure 5 that is a light-transmissive spacer without any curved surfaces and lens portions for holding a specific distance between the sensor unit 2 and the electrowetting lens device 4. Based on practical requirements, the lens structure 5 may be omitted from the camera module 1. It should be particularly pointed out that the camera module 1 may as well include a plurality of electrowetting lens devices 4 based on practical requirements.

The substrate 21 of the sensor unit 2 is formed with a plurality of first through holes 211 that are not interfered by the image sensor 22. The sealed structure 41 of the electrowetting lens device 4 is formed with a plurality of second through holes 412 that are disposed proximate to the chamber 411 with the first and second fluids 42, 43. The lens structure 5 is formed with a plurality of third through holes 51 that are not interfered by the lens portions 52, 53. The cover 23 of the sensor unit 2 is formed with a plurality of fourth through holes 231. Each of the first through holes 211 is registered with a corresponding one of the second through holes 412, a corresponding one of the third through holes 51 and a corresponding one of the fourth through holes 231. In the alternative embodiment shown in FIG. 2, the spacer 24 of the sensor unit 2 is formed with a plurality of fifth through holes 241, which is registered with a corresponding registered group of the first, second, third and fourth through holes 211, 412, 51, 231.

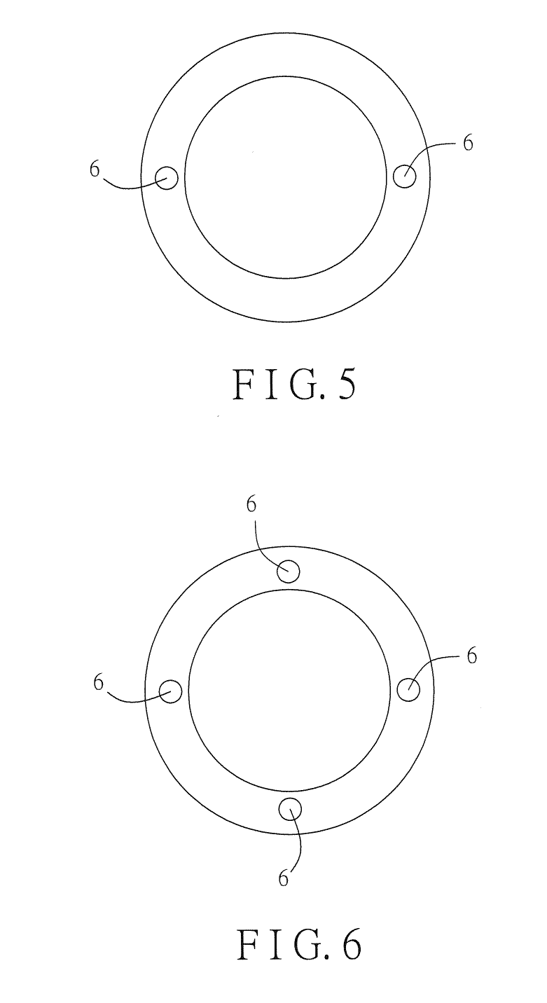

Referring to FIG. 1 and FIG. 3, each of the conductive members 6 is formed in a corresponding registered group of the first, second, third and fourth through holes 211, 412, 51, 231 and is electrically connected to the circuit board. In the alternative embodiment shown in FIG. 2, each of the conductive members (not shown) is formed in a corresponding registered group of the first, second, third, fourth and fifth through holes 211, 412, 51, 231, 241 and is electrically connected to the circuit board. The conductive members 6 are made of a conductive adhesive or a metal such as copper, gold, silver, aluminum, etc. As shown in FIG. 3, the interface 44 between the first and second fluids 42, 43 is convex relative to the image sensor 22 due to an effect of surface tension between the first and second fluids 42, 43, such that a majority of the first fluid 42 is concentrated in a middle section of the sealed structure 41. As shown in FIGS. 4 to 6, curvature and shape of the interface 44 between the first and second fluids 42, 43 are adjustably controlled due to the so-called electrowetting effect that results from opposite electric fields applied to the first and second fluids 42, 43 via the conductive members 6 under control of the circuit board to thus alter the focal length of the electrowetting lens device 4. In this embodiment, the interface 44 becomes concave relative to the image sensor 22 when a positive electric field is applied to the first fluid 42 and a negative electric field is applied to the second fluid 43. The present invention is not limited to how the electric field is applied to the first and second fluids 42, 43, two examples are shown in FIGS. 5 and 6.

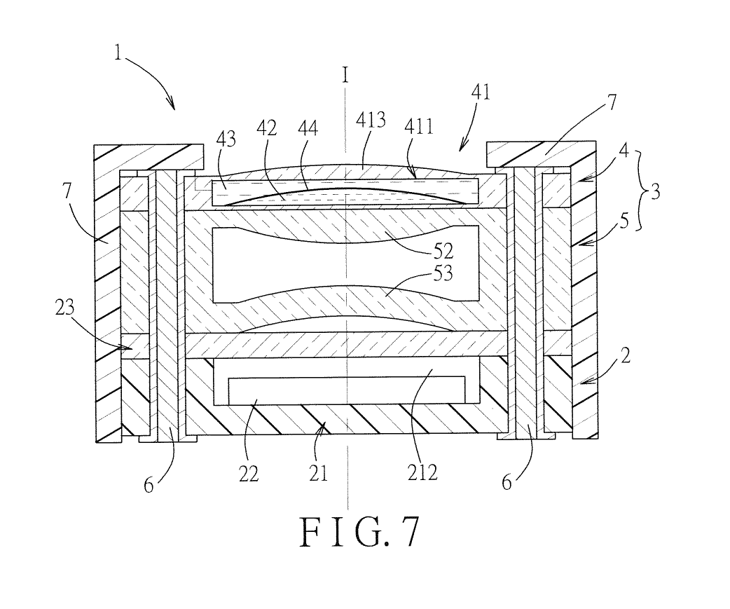

Referring further to FIG. 7, in another alternative embodiment of the present invention, the camera module 1 further includes a holder 7 for light shielding leakage reducing purposes. The holder 7 covers side walls of the sensor unit 2 and the lens unit 3, as well as tops of the conductive members 6, without blocking light passages through the image sensor 22, the lens portions 52, 53 and the electrowetting lens device 4.

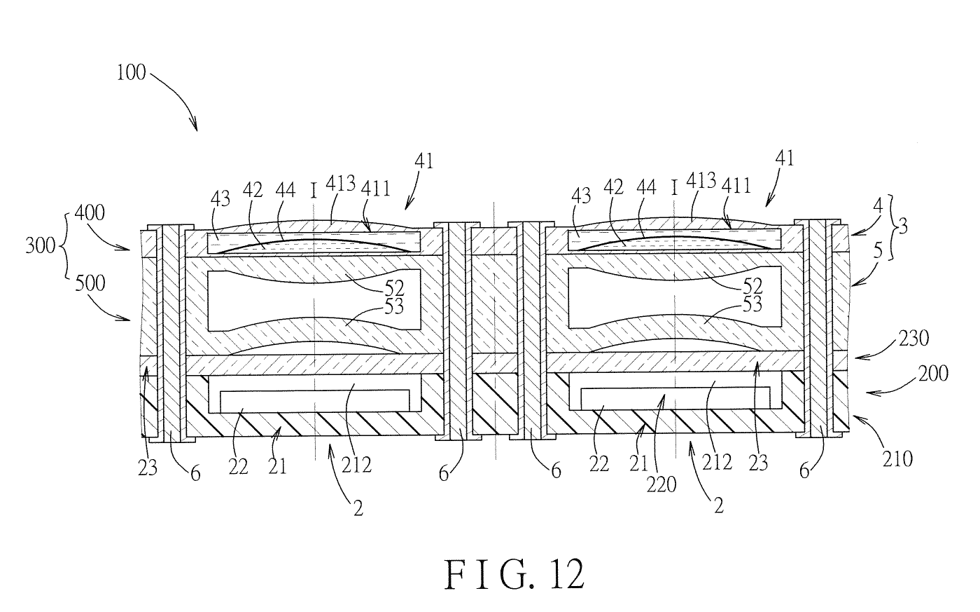

Referring to FIG. 12, according to the embodiment of the present invention, a camera module assembly 100 is provided. The camera module assembly 100 includes a sensor unit array 200, a lens unit array 300, and a plurality of the conductive members 6. The lens unit array 300 is disposed on the sensor unit array 200 and includes an electrowetting lens device array 400 and a lens structure array 500.

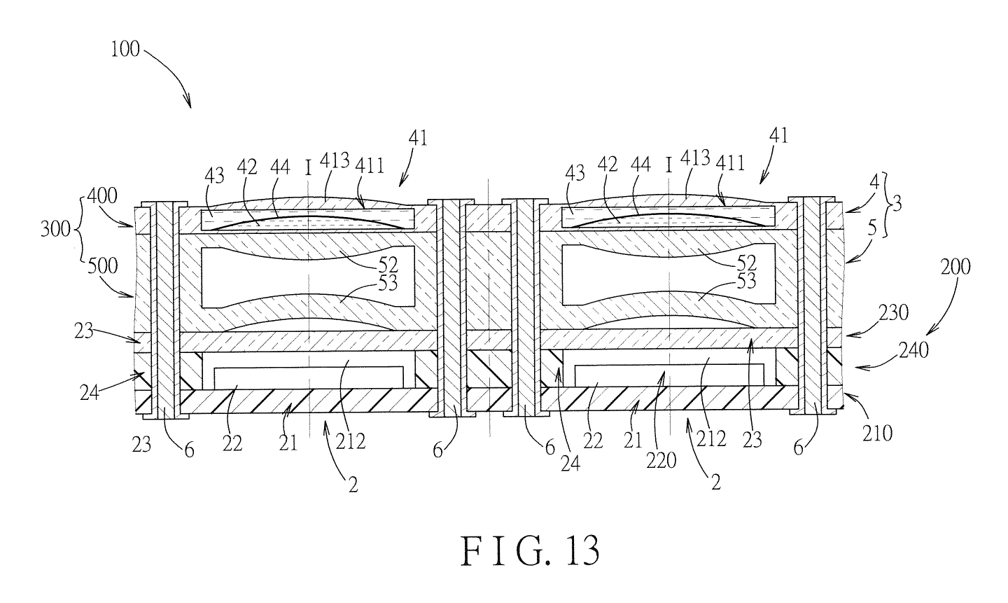

The sensor unit array 200 includes a wafer-like substrate array 210 including a plurality of the substrates 21 and an image sensor array 220 including a plurality of the image sensors 22. The image sensor array 220 is disposed on the substrate array 210 in such a way that each of the image sensors 22 is disposed on a corresponding one of the substrates 21 to form a plurality of the sensor units 2. Each of the substrates 21 of the substrate array 210 may be the circuit board formed with the recess 212 at the top surface thereof for placement of the corresponding one of the image sensors 22 of the image sensor array 220. In the alternative embodiment, referring further to FIG. 13, each of the substrates 21 of the substrate array 210 may be the flat circuit board, and the sensor unit array 200 further includes a spacer array 240 including a plurality of the spacers 24. Each of the spacers 24 is disposed on a corresponding one of the substrates 21 of the substrate array 210 and surrounds a corresponding one of the image sensors 22 of the image sensor array 220. It should be noted that each of the substrates 21 of the substrate array 210 may also be the holding plate made of e.g., ceramics, plastics, etc. while each of the sensor units 2 further includes a circuit board (not shown) disposed below a corresponding one of the substrates 21. Each of the image sensors 22 is electrically connected to a corresponding one of the circuit boards.

The sensor unit array 200 further includes a cover array 230 including a plurality of the covers 23. Each of the covers 23 covers a corresponding stacked pair of the substrates 21 and the image sensors 22. In other embodiment, the cover array 230 may be omitted.

The electrowetting lens device array 400 includes a plurality of the electrowetting lens devices 4. Each of the electrowetting lens devices 4 includes the sealed structure 41. The electrowetting lens device array 400 is disposed on the sensor unit array 200 in such a way that the sealed structure 41 of each of the electrowetting lens devices 4 is aligned with a corresponding one of the image sensors 22 along a corresponding optical axis I. The sealed structure 41 has one side that is opposite to the corresponding image sensors 22 and that is formed with the lens 413 for condensing incident light.

The sealed structure 41 of each of the electrowetting lens devices 4 is formed with the chamber 411. Each of the electrowetting lens devices 4 further includes the first and second fluids 42, 43 that are accommodated in the chamber 411. The first fluid 42 and the second fluid 43 are immiscible such that the optical interface 44 is formed therebetween to be aligned with the corresponding one of the image sensors 22 along the corresponding optical axis I.

The lens structure array 500 includes a plurality of the lens structures 5. The lens structure array 500 may be disposed between the electrowetting lens device array 400 and the sensor unit array 200, as is illustrated in FIG. 12, or may be disposed on the electrowetting lens device array 400 opposite to the sensor unit array 200. Each of the lens structures 5 is aligned with a corresponding one of the sensor units 2 and a corresponding one of the electrowetting lens devices 4 along the corresponding optical axis I. Each of the lens structures 5 may further include the at least one lens portion that is aligned with the image sensor 22 of the corresponding one of the sensor units 2 along the corresponding optical axis I. In the embodiment of the present invention, each of the lens structures 5 includes the first and second lens portions 52, 53.

Each of the substrates 21 is formed with a plurality of the first through holes 211 that are not interfered by the corresponding one of the image sensors 22. Each of the sealed structures 41 is formed with a plurality of the second through holes 412 that are disposed proximate to the first and second fluids 42, 43 of the corresponding electrowetting lens device 4. Each of the lens structures 5 is formed with a plurality of the third through holes 51 that are not interfered by the lens portions 52, 53. Each of the covers 23 is formed with a plurality of the fourth through holes 231. Each of the first through holes 211 is registered with a corresponding one of the second through holes 412, a corresponding one of the third through holes 51 and a corresponding one of the fourth through holes 231.

Each of the conductive members 6 is formed in a corresponding registered group of the first, second, third and fourth through holes 211, 412, 51, 231 and is electrically connected to a corresponding one of the circuit boards. In the alternative embodiment illustrated in FIG. 13, each of the spacers 24 is formed with a plurality of the fifth through holes 241, which is aligned with a corresponding registered group of the first, second, third and fourth through holes 211, 412, 41, 231, and each of the conducive members 6 is received in a corresponding registered group of the first, second, third, fourth and fifth through holes 211, 412, 51, 231, 241. Curvature and shape of the interface 44 between the first and second fluids 42, 43 of each of the electrowetting lens devices 4 are adjustably controlled by an electric field applied to a corresponding group of the conductive members 6 under control of the circuit board.

Since detailed structures and arrangements of each of the sensor units 2, the lens units 3, the electrowetting lens devices 4 and the lens structures are described previously, the same will not be elaborated further herein for the sake of brevity.

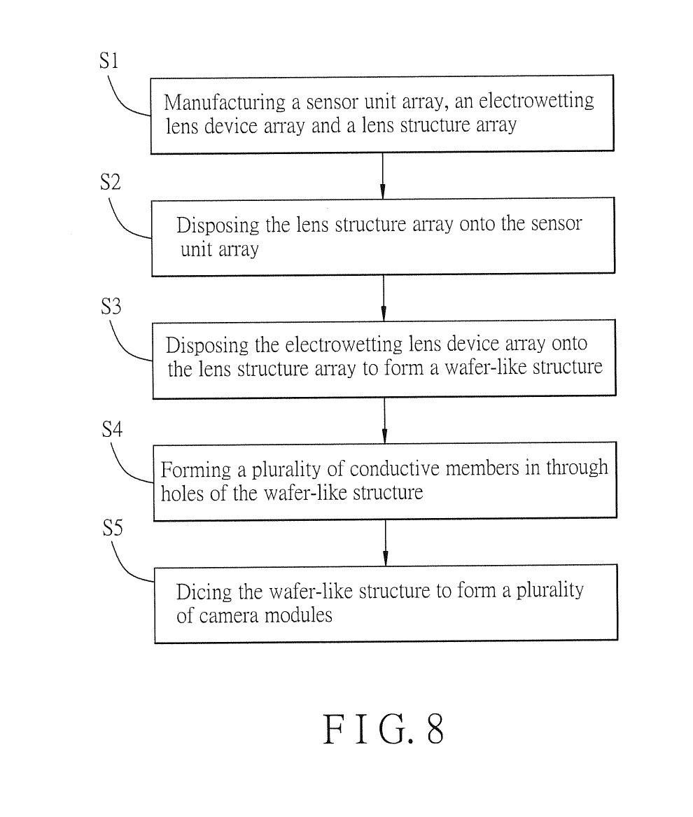

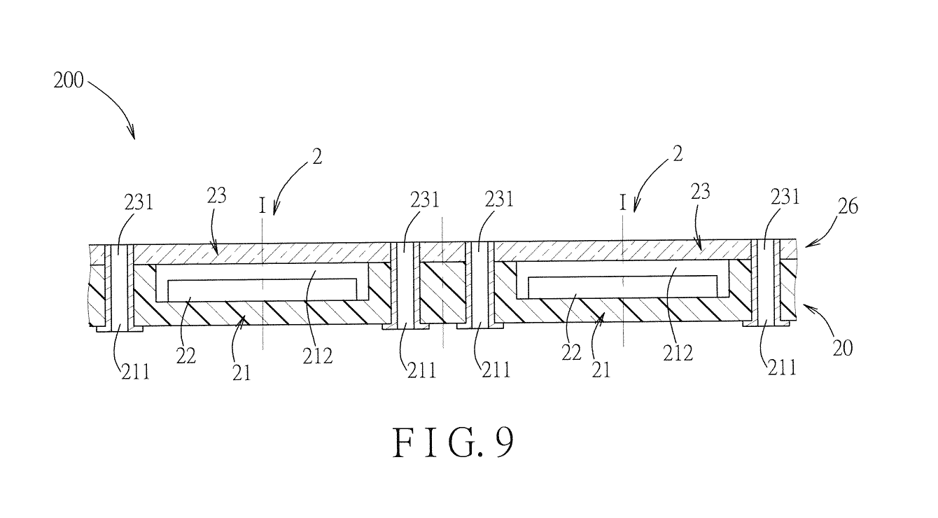

Referring to FIGS. 8 to 12, according to the embodiment of this invention, a method for manufacturing a plurality of the camera modules 1 is provided.

In step S1, the sensor unit array 200, and the lens unit array 300 including the electrowetting lens device array 400 and the lens structure array 500 are first respectively provided.

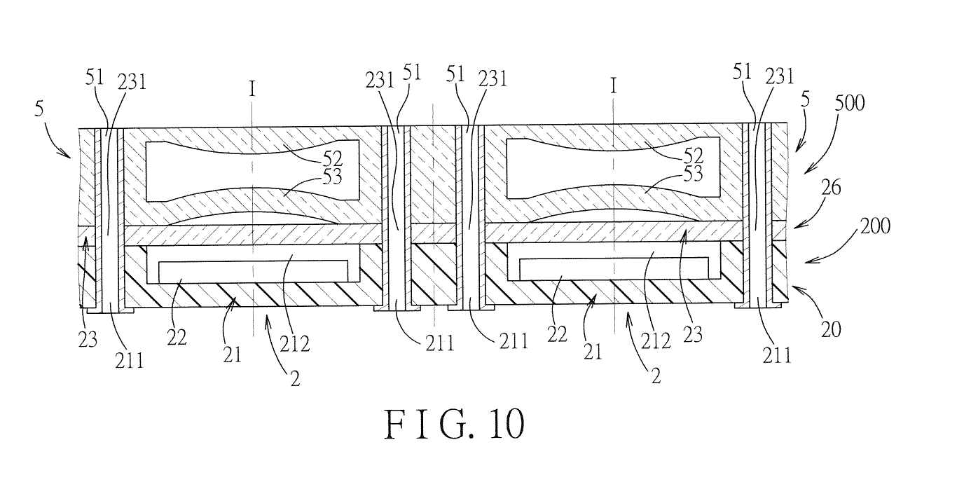

In step S2, the lens structure array 500 is disposed onto and secured to the sensor unit array 200 in such a way that the lens portions 52, 53 of each of the lens structures 5 are aligned with a corresponding one of the image sensors 22 along a corresponding optical axis, and that the third through holes 51 are respectively registered with the first and fourth through holes 211, 231 (see FIG. 10).

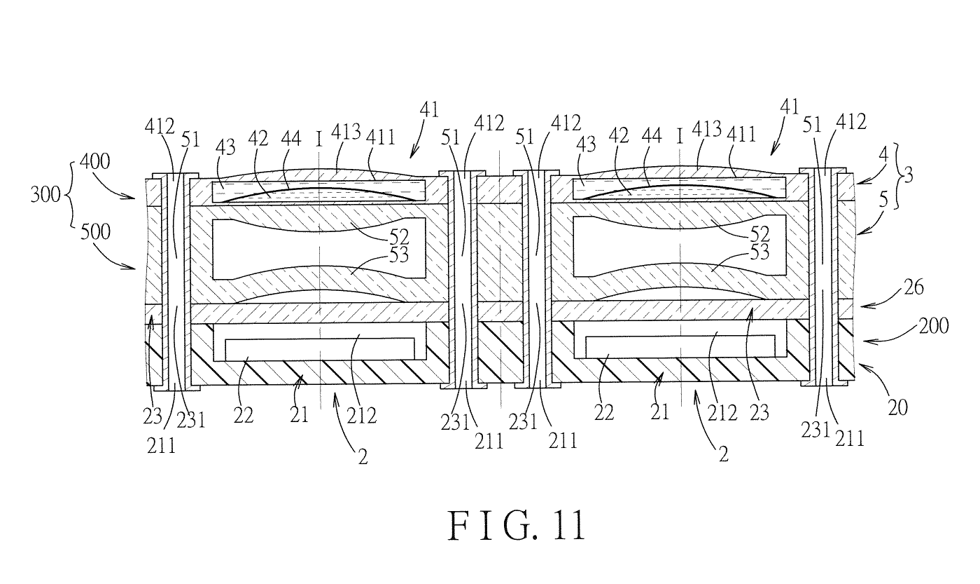

Then, in step S3, the electrowetting lens device array 400 is disposed onto and secured to the lens structure array 500 in such a way that the sealed structure 41 of each of the electrowetting lens devices 4 is aligned with a corresponding one of the image sensors 22 and the lens portions 52, 53 of a corresponding one of the lens structures 5 and that the second through holes 412 are respectively registered with the third through holes 51. It should be noted that, based on practical requirements, the electrowetting lens device array 400 may be first disposed onto the sensor unit array 200 followed by disposing the lens structure array 500 onto the electrowetting lens device array 400. At this time, a wafer-like structure is formed (see FIG. 11).

In step S4, after formation of the wafer-like structure, a plurality of the conductive members 6 are respectively formed in the registered groups of the first, second, third and fourth through holes 211, 412, 51, 231 and are each electrically connected to the circuit board of a corresponding one of the sensor units 2.

It needs to be particularly pointed out that the first, second, third and fourth through holes 211, 412, 51, 231 may be separately formed during manufacture of the sensor unit array 200, the electrowetting lens device array 400, and the lens structure array 500, as illustrated herein, or may be formed altogether after the perforation-free sensor unit array 200, electrowetting lens device array 400, and lens structure array 500 are stacked together. In addition, in an alternative implementation, portions of the conductive members 6 may be separately formed in the first, second, third and fourth through holes 211, 412, 51, 231 during fabrication of the respective sensor unit array 200, electrowetting lens devices array 400 and lens structure array 500, to constitute the conductive members 6 once the sensor unit array 200, the electrowetting lens devices array 400 and the lens structure array 500 are stacked and aligned together (see FIGS. 12 and 13). The conductive members 6 may be formed by injecting silver paste into the registered groups of through holes followed by curing treatment. The conductive members 6 may also be formed by metal deposition techniques.

After formation of the conductive members 6, in step S5, the wafer-like structure is diced (e.g., along the dashed lines shown in FIGS. 12 and 13) to form a plurality of the camera modules 1.

In sum, the present invention provides a camera module 1 with a simple, light-weight structure, that has low energy consumption, that is fast auto focusing and zooming, cost efficient and easy to manufacture. The present invention also provides a camera module assembly 100 that includes a plurality of the camera modules 1. According to another aspect of this invention, a fast and cost effective method for manufacturing a plurality of the camera modules 1 is provided.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A camera module, comprising:
a sensor unit including a substrate and an image sensor disposed on said substrate, said substrate being formed with a plurality of first through holes that are not interfered by said image sensor;
a lens unit disposed on said sensor unit and including an electrowetting lens device, said electrowetting lens device including a sealed structure that is aligned with said image sensor along an optical axis and that is formed with a plurality of second through holes, each of said second through holes being registered with a corresponding one of said first through holes; and
a plurality of conductive members, each of which is formed in a corresponding registered pair of said first and second through holes.

2. The camera module of claim 1, wherein said lens unit further includes a lens structure that is aligned with said sensor unit and said electrowetting lens device along the optical axis, said lens structure being formed with a plurality of third through holes, each of which is registered with a corresponding registered pair of said first and second through holes, each of said conductive members being formed in a corresponding registered group of said first, second and third through holes.

3. The camera module of claim 2, wherein said lens structure has at least one lens portion that is aligned with said image sensor along the optical axis.

4. The camera module of claim 1, wherein said sensor unit further includes a light-transmissive cover covering said substrate and said image sensor, and formed with a plurality of fourth through holes, each of said fourth through holes being registered with a corresponding registered pair of said first and second through holes, each of said conductive members being formed in a corresponding group of the first, second and fourth through holes.

5. The camera module of claim 1, wherein said sealed structure of said electrowetting lens device is made from a light-transmissive material, one side of said sealed structure opposite to said image sensor being formed with a lens.

6. The camera module of claim 1, wherein said substrate of said sensor unit is formed with a recess at a top surface thereof for placement of said image sensor, said first through holes being formed outside of said recess.

7. The camera module of claim 1, wherein said sensor unit further includes a spacer that is disposed on said substrate and that surrounds said image sensor, said spacer being formed with a plurality of fifth through holes, each of which is registered with a corresponding registered pair of said first and second through holes, each of said conductive members being formed in a corresponding group of the first, second and fifth through holes.

8. The camera module of claim 1, wherein said sealed structure of said electrowetting lens device is formed with a chamber, said electrowetting lens device further including a first fluid and a second fluid that are accommodated in said chamber of said sealed structure, said first fluid being conductive, said first and second fluids being immiscible such that an optical interface is formed therebetween to be aligned with said image sensor along the optical axis, said second through holes being disposed proximate to said first and second fluids.

9. The camera module of claim 8, wherein said substrate is a circuit board which is electrically connected to said conductive members, curvature and shape of said interface between said first and second fluids being adjustably controlled by the electric field applied to said conductive members under control of said circuit board.

10. The camera module of claim 8, wherein said sensor unit further includes a circuit board that is disposed below said substrate and that is electrically connected to said conductive members, curvature and shape of said interface between said first and second fluids being adjustably controlled by the electric field applied to said conductive members under control of said circuit board.

11. The camera module of claim 1, further comprising a light-shielding holder covering at least side walls of said sensor unit and said lens unit without blocking light passage through said image sensor and said electrowetting lens device.

12. A camera module assembly, comprising:
a sensor unit array including a wafer-like substrate array that includes a plurality of substrates and an image sensor array that includes a plurality of image sensors, said image sensor array being disposed on said substrate array in such a way that each of said image sensors is disposed on a corresponding one of said substrates to form a plurality of sensor units, each of said substrates being formed with a plurality of first through holes;
a lens unit array being made up of a plurality of lens units and including an electrowetting lens device array that includes a plurality of electrowetting lens devices, each of said electrowetting lens devices including a sealed structure that is formed with a plurality of second through holes, said lens unit array being disposed on said sensor unit array in such a way that said sealed structure of each of said electrowetting lens devices is aligned with a corresponding one of said image sensors along a corresponding optical axis, each of said second through holes being registered with a corresponding one of said first through holes; and
a plurality of conductive members that are respectively formed in said registered pairs of the first and second through holes.

13. The camera module assembly of claim 12, wherein each of said substrates of said substrate array is formed with a recess at a top surface thereof for placement of the corresponding one of said image sensors of said image sensor array, said first through holes being formed outside of said recess.

14. The camera module assembly of claim 12, wherein said sealed structure of each of said electrowetting lens devices is formed with a chamber, each of said electrowetting lens devices further including a first fluid and a second fluid that are accommodated in said chamber, said first fluid being conductive, said first and second fluids being immiscible such that an optical interface is formed therebetween to be aligned with the corresponding one of said image sensors along the corresponding optical axis, said second through holes of each of said electrowetting lens devices being disposed proximate to said first and second fluids of said electrowetting lens device.

15. The camera module assembly of claim 14, wherein each of said substrates of said substrate array is a circuit board that is electrically connected to a corresponding group of said conductive members, curvature and shape of the interface between said first and second fluids of each of said electrowetting lens devices being adjustably controlled by an electric field applied to the corresponding group of said conductive members under control of said circuit board.

16. The camera module assembly of claim 14, wherein each of said sensor units of said sensor unit array further includes a circuit board that is disposed below a corresponding one of said substrates and that is electrically connected to a corresponding group of said conductive members, curvature and shape of the interface between said first and second fluids of each of said electrowetting lens devices being adjustably controlled by an electric field applied to the corresponding group of said conductive members under control of said circuit board.

17. The camera module assembly of claim 12, wherein said lens unit array further includes a lens structure array including a plurality of lens structures, each of said lens structures being aligned with a corresponding one of said sensor units and a corresponding one of said electrowetting lens devices along the corresponding optical axis, each of said lens structures being formed with a plurality of third through holes, each of which is registered with a corresponding registered pair of said first and second through holes, each of said conductive members being received in a respective registered group of said first, second and third through holes.

18. The camera module assembly of claim 12, wherein said sensor unit array further includes a cover array including a plurality of light-transmissive covers, each of said covers covering a corresponding one of said substrates and a corresponding one of said image sensors, and being formed with a plurality of fourth through holes, each of said fourth through holes being registered with a corresponding registered pair of said first and second through holes, each of said conductive members being received in a respective group of said first, second and fourth through holes, each of said conductive members being received in a respective group of said first, second and fourth through holes.

19. The camera module assembly of claim 12, wherein said sensor unit array further includes a spacer array including a plurality of spacers, each of said spacers being disposed on a corresponding one of said substrates of said substrate array and surrounding a corresponding one of said image sensors of said image sensor array, each of said spacers being formed with a plurality of fifth through holes, each of which is registered with a corresponding registered pair of said first and second through holes, each of said conductive members being received in a respective group of said first, second and fifth through holes.

20. A method of manufacturing a plurality of camera modules, comprising the steps of:
(A) forming a wafer-like structure including a sensor unit array and a lens unit array stacked on the sensor unit array, the sensor unit array including a substrate array that includes a plurality of substrates and an image sensor array that includes a plurality of image sensors respectively disposed on the substrates of the substrate array to form a plurality of sensor units, the lens unit array being made up of a plurality of lens units and including an electrowetting lens device array that includes a plurality of electrowetting lens devices, each of the electrowetting lens devices including a sealed structure that is aligned with a corresponding one of the image sensors along a corresponding optical axis, each of stacked pairs of the sensor units and the lens units is formed with a plurality of registered pairs of a first through hole and a second through hole;
(B) forming a plurality of conductive members respectively in the registered pairs of the first and second through holes; and
(C) after step (B), dicing the wafer-like structure to form a plurality of camera modules, each of the camera modules including one of the sensor units, one of the lens units and a plurality of the conductive members.

21. The method of claim 20, wherein step (A) includes the sub-steps of:
(A1) manufacturing the sensor unit array, each of the substrates of the substrate array of the sensor unit array being formed with a plurality of the first through holes that are not interfered by the respective one of the image sensors;
(A2) manufacturing the lens unit array, the sealed structure of each of the electrowetting lens devices of the lens unit array being formed with a plurality of the second through holes; and
(A3) disposing the lens unit array onto the sensor unit array in such a way that the sealed structure of each of the electrowetting lens devices is aligned with the corresponding one of the image sensors along the corresponding optical axis, and that each of the second through holes is registered with a corresponding one of the first through holes, in order to form the wafer-like structure.

22. The method of claim 21, wherein, in sub-step (A2), the lens unit array further includes a lens structure array that includes a plurality of lens structures, each of the lens structures having at least one lens portion and being formed with a plurality of third through holes;
sub-step (A3) including the sub-steps of
(A31) disposing the lens structure array onto the sensor unit array in such a way that the at least one lens portion of each of the lens structures is aligned with a corresponding one of the image sensors along the corresponding optical axis, and that each of the third through holes is registered with a corresponding one of the first through holes, and
(A32) disposing the electrowetting lens device array onto the lens structure array in such a way that the sealed structure of each of the electrowetting lens devices is aligned with the corresponding one of the image sensors and a corresponding one of the lens portions, and that each of the second through holes is registered with a corresponding registered pair of the first and third through holes;
in step (B), each of the conductive members being formed in a corresponding registered group of the first, third and second through holes.

23. The method in claim 21, wherein, in sub-step (A2), the lens unit array further includes a lens structure array that includes a plurality of lens structures, each of the lens structures having at least one lens portion and being formed with a plurality of third through holes;
sub-step (A3) including the sub-steps of
(A31) disposing the electrowetting lens device array onto the sensor unit array in such a way that the sealed structure of each of the electrowetting lens devices is aligned with the corresponding one of the image sensors along the corresponding optical axis, and that each of the second through holes is registered with the corresponding one of the first through holes, and
(A32) disposing the lens structure array onto the electrowetting lens device array in such a way that the at least one lens portion of each of the lens structures is aligned with a corresponding one of the image sensors and the sealed structure of a corresponding one of the electrowetting lens devices along the corresponding optical axis, and that each of the third through holes is registered with a corresponding registered pair of the first and second through holes;
in step (B), each of the conductive members being formed in a corresponding registered group of the first, second and third through holes.

24. The method of claim 21, wherein in sub-step (A1), the sensor unit array further includes a light-transmissive cover array including a plurality of light-transmissive covers, each of the covers being formed with a plurality of fourth through holes;
sub-step (A1) including the sub-steps of
(A11) disposing each of the image sensors on the respective one of the substrates, and
(A12) disposing the cover array onto the sensor unit array in such a way that each of the covers covers a corresponding one of the image sensors and a corresponding one of the substrates, and that each of the fourth through holes is registered with a corresponding one of the first through holes;
in sub-step (A3), each of the second through holes being further registered with a corresponding one of the fourth through holes;
in step (B), each of the conductive members being formed in a corresponding group of the first, fourth and second through holes.

25. The method of claim 20, further comprising the step of:
(D) for each of the camera modules, forming a light-shielding holder that covers at least side walls of the sensor unit and the lens unit without blocking light passage through the image sensor and the electrowetting lens device.
